(19) United States
(12) Patent Application Publication
(10) Pub. No.: US 2016/0171427 A1
(43) Pub. Date: Jun. 16, 2016

(54) PARCEL DELIVERY MANAGEMENT SYSTEM AND METHOD THEREOF

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: DAN CAO, Shenzhen (CN)

(21) Appl. No.: 14/825,528

(22) Filed: Aug. 13, 2015

(30) Foreign Application Priority Data
Dec. 10, 2014 (CN) 201410751243.9

(51) Int. Cl. G06Q 10/08

(52) U.S. Cl. CPC G06Q 10/083

(57) ABSTRACT

A parcel delivery management method includes: providing an information input interface and displaying the information input interface on a handheld device to input and acquire waybill number information of at least one parcel to be delivered and courier identification information of a courier, associating the courier identification information with the waybill number information, and adding the associated courier identification information and the waybill number information to a relationship table; acquiring location information of a handheld device carried by the courier and the courier identification information; determining recipient contact information of the recipients whose recipient address are within a certain range from the location of the handheld device carried by the courier according to the acquired location information of the handheld device; and informing the recipient whose recipient address is within the preset area to receive the corresponding parcel according to the recipient contact information.

### CROSS-REFERENCE TO RELATED APPLICATIONS

This application claims priority to Chinese Patent Application No. 201410751243.9 filed on Dec. 10, 2014, the contents of which are incorporated by reference herein.

### FIELD

The subject matter herein generally relates to parcel delivery field, and particularly to a parcel delivery management system and method.

### BACKGROUND

When delivering a parcel to a recipient, a courier usually contacts the recipient by calling or sending a message after reaching a destination of the parcel. However, the recipient may not be at the destination when the courier arrives.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of a parcel delivery management system.

FIG. 2 is a diagrammatic view of an exemplary embodiment of a running environment of the system of FIG. 1.

FIG. 3 is a diagrammatic view of an exemplary embodiment of an information table of the system of FIG. 1.

FIG. 4 is a diagrammatic view of an exemplary embodiment of a relationship table of the system of FIG. 1.

FIG. 5 is a block diagram of an exemplary embodiment of a query interface of the system of FIG. 1.

FIG. 6 is a flowchart of an exemplary embodiment of a parcel delivery management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives.

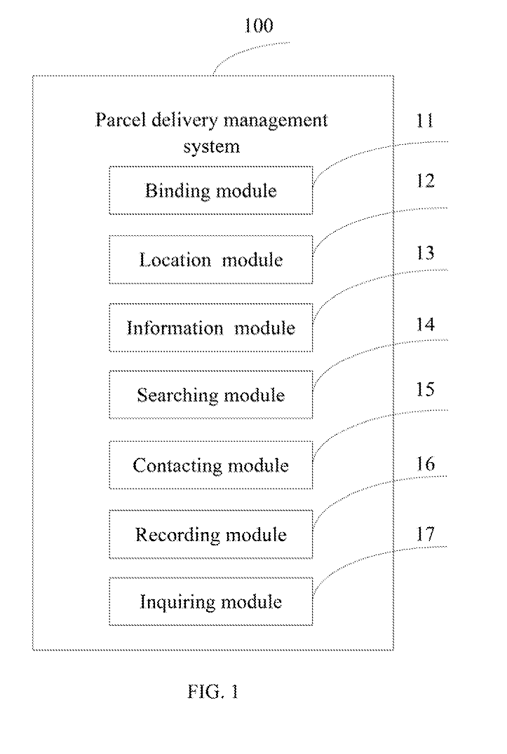

FIG. 1 is a block diagram of an exemplary embodiment of a parcel delivery management system. The parcel delivery management system 100 includes a binding module 11, a location module 12, an information module 13, a searching module 14, a contacting module 15, a recording module 16, and an inquiring module 17. In the embodiment, the modules of the system 100 are collection of software instructions executed by one or more processors.

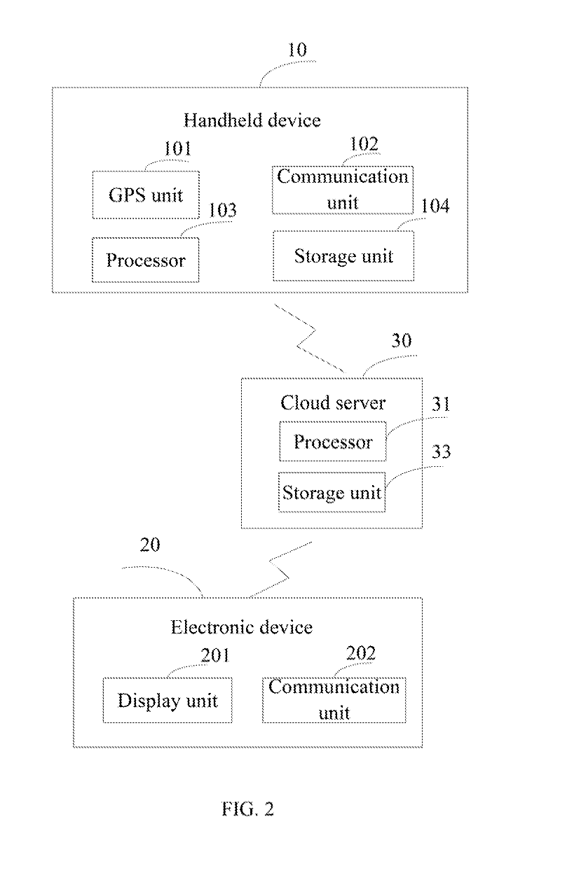

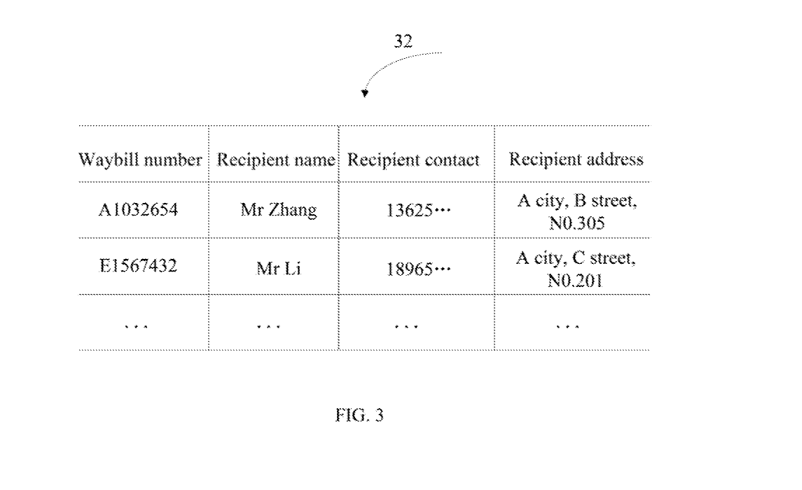

FIG. 2 is a diagrammatic view diagram of an exemplary embodiment of a running environment of the parcel delivery management system of FIG. 1. The running environment of the parcel delivery management system 100 includes a handheld device 10, an electronic device 20, and a cloud server 30. The handheld device 10 and the electronic device 20 are connected to the cloud server 30 via corresponding networks. The cloud server 30 stores an information table 32, for example, as that shown in FIG. 3 which is a diagrammatic view diagram of an exemplary embodiment of an information table of the parcel delivery management system of FIG. 1. The information table 32 records information of waybill number, recipient address, recipient name, and recipient contact for at least one parcel to be delivered. The waybill number, the recipient address, the recipient name, and the contact for one parcel are recorded in one corresponding row of the information table 32 and are corresponding to each other.

The handheld device 10 includes a Global Positioning System (GPS) unit 101, a communication unit 102, a processor 103, and a storage unit 104. The GPS unit 101 is used to determine location of the handheld device 10 and/or a courier using the handheld device 10. The handheld device 10 is connected to the cloud server 30 through the network via the communication unit 102. The location module 12 is stored in the storage unit 104 and executed by the processor 103. In the embodiment, the handheld device 10 can be a mobile phone, a portable computer, a tablet computer, and the like.

The electronic device 20 includes a display unit 201 and a communication unit 202. In the embodiment, the display unit 201 is a touch screen, in another embodiment, the display unit 201 can be a display screen and capable of combining a keyboard or a touchpad to constitute an input/output device. The electronic device 20 is connected to the cloud server 30 through the network via the communication unit 202. The electronic device 20 can be a mobile phone, a portable computer, a tablet computer, and the like.

The network among the cloud server 30, the handheld device 10, and the electronic device 20 can be an internet, an on-demand virtual lease line, a wireless network including WIFI and BLUETOOTH, a telecommunication network including a General Packet Radio Service (GPRS) network, a Code Division Multiple Access (CDMA) network, or a broadcasting network. The network between the handheld device 10 and the cloud server 30 and the network between the cloud server 30 and the electronic device 20 can be the same or different. The networks can be a public network or a private network. The communication units 102, 202 can be communication chips complying with the corresponding networks.

The cloud server 30 includes at least one processor 31 and a storage unit 33. The information table 32 is stored in the storage unit 33.

In the embodiment, the binding module 11, the information module 13, the searching module 14, the contacting module 15, the recording module 16, and the inquiring module 17 can be collections of software instructions stored in the storage unit 33 of the cloud server 30 and executed by the processor 31 of the cloud server 30. The location module 12, can be collections of software instructions stored in the storage unit 104 of the handheld device 10 and executed by the processor 103 of the handheld device 10. The modules of the parcel delivery management system 100 also can include functionality represented as hardware or integrated circuits, or as software and hardware combinations, such as a special-purpose processor or a general-purpose processor with special-purpose firmware.

In at least one embodiment, each one of the processors 103, 31 can be a central processing unit, a digital signal processor, or a single chip, for example. In at least one embodiment, each one of the storage units 104, 33 can be an internal storage system, such as a flash memory, a Random Access Memory (RAM) for temporary storage of information, and/or a Read-Only Memory (ROM) for permanent storage of information. Each one of the storage units 104, 33 can also be a storage system, such as a hard disk, a storage card, or a data storage medium. Each one of the storage units 104, 33 can include volatile and/or non-volatile storage devices. In at least one embodiment, each one of the storage units 104, 33 can include two or more storage devices such that one storage device is a memory and the other storage device is a hard drive. Additionally, one or more of the storage units 104, 33 can be respectively located either entirely or partially external relative to the cloud server 30 and the handheld device 10.

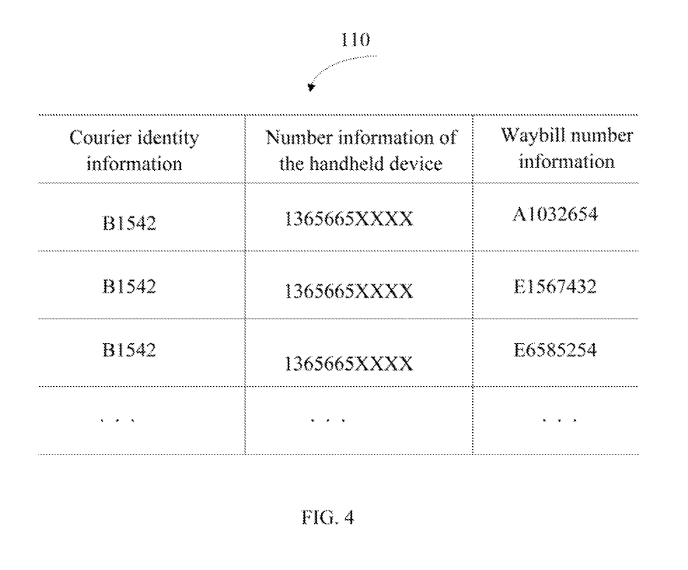

The binding module 11 provides an information input interface and display the information input interface on the handheld device 10 to input and acquire the courier identification information and the waybill number information of at least one parcel to be delivered, and associates the courier identification information with the waybill number information of the parcel to be delivered. The binding module 11 adds the associated courier identification information and the waybill number information to a relationship table 110, stored in the storage device 33 of the cloud server 30, as shown in FIG. 4.

As shown in FIG. 4, the courier identification information includes, but is not limited to, courier identity information and/or number information of the handheld device 10. The courier identity information can be a combination of letters and numerals and is used to distinguish the identity of the courier. In the embodiment, the binding module 11 provides the information input interface and displays the information input interface on the handheld device 10 or a computer for a user, such as the courier or other people, to input the courier identity information, the number information of the handheld device 10, and the waybill number information, the binding module 11 acquires the above input information and adds the input information to the relationship table 110.

In the embodiment, when the courier needs to deliver a parcel, the binding module 11 provides the information input interface on the handheld device 10 used by the courier in response to an operation of the courier. The courier can input the courier identity information and/or the number information of the handheld device 10 via the information input interface manually or by scanning a work card, and input the waybill number information by scanning a bar code on a waybill of the parcel to be delivered via the handheld device 10 or a scanner connected to the handheld device 10. The bar code on the waybill contains the waybill number information. In other embodiments, the information input interface provided by the binding module 11 can be displayed on a computer connected to the cloud server 30. The courier inputs the waybill number information by scanning the bar code on the waybill via the scanner connected to the computer.

The location module 12 acquires the location information of the handheld device 10 determined by the GPS unit 101 of the handheld device 10, and sends the acquired location information of the handheld device 10 and the courier identification information to the cloud server 30. In the embodiment, the courier identification information can only include the number information of the handheld device 10, such as a cell phone number. Obviously, when the location module 12 sends the acquired location information of the handheld device 10 to the cloud server 30, the location module 12 simultaneously sends the cell phone number of the handheld device 10 to the cloud server 30.

The information module 13 acquires the location information of the handheld device 10 carried by the courier and the courier identification information.

The searching module 14 determines the recipient contact information of the recipients whose recipient address are within a certain range from the location of the handheld device 10 carried/used by the courier according to the acquired location information of the handheld device 10, the courier identification information, the information table 32, and the relationship table 110. In detail, the searching module 14 determines whether the location of the handheld device 10 carried by the courier is in a preset area, and acquires the waybill numbers corresponding to the courier identification information according to the courier identification information and the relationship table 110 when the location of the handheld device 10 is in the preset area. The searching module 14 further acquires all of the recipient addresses corresponding to the acquired waybill numbers according to the information table 32, and determines which recipient addresses are located in the preset area. The searching module 14 determines the recipient contact information of each recipient whose address is within the preset area. In the embodiment, the preset area can be within a range of a few kilometers from a particular place. For example, the preset area can be an area two kilometers from a community. Furthermore, the searching module 14 also divides a delivery area, which the courier is responsible for, into a number of preset areas.

The contacting module 15 informs the recipient whose recipient address is within the preset area to receive the corresponding parcels according to the recipient contact information determined by the searching module 14. In the embodiment, the recipient contact information can be a phone number. The contacting module 15 calls up the recipient or sends a message to the recipient to inform the recipient to receive the parcels. Therein, the message sent by the contacting module 15 includes delivery place and waiting time information. For example, the message may be “Hello, your parcel is on the way, please come to receive your parcel in a XX building at 3'O clock, PM”.

The recording module 16 is used to acquire and add the waybill number, the recipient address, the recipient name, and the recipient contact information recorded in a waybill to the information table 32 in response to an operation of inputting information by the courier when the courier receives a parcel with the waybill.

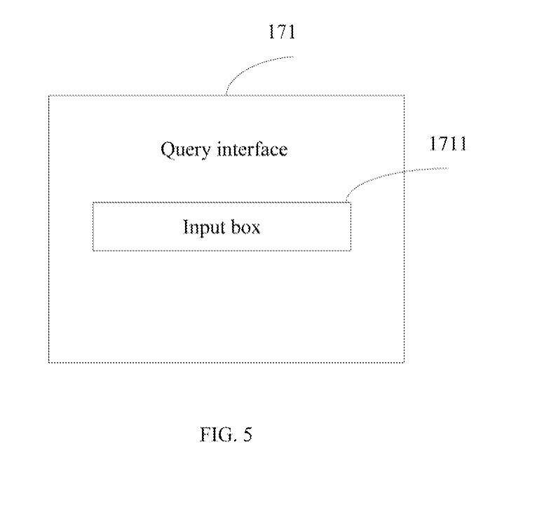

The inquiring module 17 provides a query interface 171 and displays the query interface 171 on the display unit 201 of the electronic device 20 carried by a user to inquire delivering information of the parcels for the user. In the embodiment, the delivering information includes default delivery time and location of the parcel. FIG. 5 illustrates the query interface 171 includes an input box 1711 provided for the user to input the waybill numbers of the parcel. The inquiring module 17 can acquire the waybill numbers of the parcel input by the user, and further determine the courier identification information corresponding to the waybill numbers according to the relationship table 110. The inquiring module 17 can determine the default delivery time and location of the parcel according to the determined courier identification information, and display the default delivery time information and location of the parcel on the query interface 171. In the present embodiment, the inquiring module 17 determines the location of the parcel according to the determined courier identification information corresponding to the location information of the handheld device 10 acquired in the information module 13. In the present embodiment, the default delivery time of the parcel can be set by default and the courier delivers the parcel according to the default delivery time. In other embodiments, the default delivery time is set by the courier.

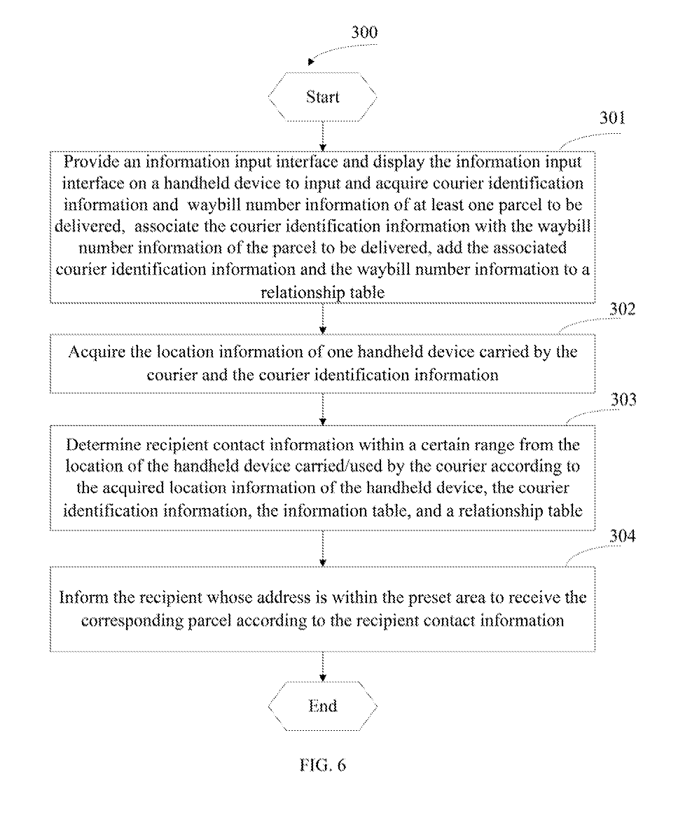

FIG. 6 is a flowchart of an example embodiment of a parcel delivery management method. An example parcel delivery management method 300 is provided by way of example, as there are a variety of ways to carry out the method. The example method 300 described below can be carried out using the configurations illustrated in FIGS. 1-5, and various elements of these figures are referenced in explaining the example method. Each block shown in FIG. 6 represents one or more processes, methods, or subroutines, carried out in the example method 300. Furthermore, the illustrated order of blocks is illustrative only and the order of the blocks can be changed according to the present disclosure. The example method 300 can begin at block 301. Depending on the embodiment, additional blocks can be utilized and the ordering of the blocks can be changed.

At block 301, a binding module provides an information input interface and display the information input interface on a handheld device to input and acquire courier identification information and waybill number information of at least one parcel to be delivered, and associates the courier identification information with the waybill number information of the parcel to be delivered. The binding module adds the associated courier identification information and the waybill number information to a relationship table. The courier identification information includes, but is not limited to courier identity information and/or number information of the handheld device.

At block 302, an information module acquires location information of the handheld device carried by the courier and the courier identification information. In the embodiment, the courier identification information only includes the number information of the handheld device, such as a cell phone number of the handheld device.

At block 303, a searching module determines recipient contact information within a certain range from the location of the handheld device carried/used by the courier according to the acquired location information of the handheld device, the courier identification information, an information table, and the relationship table. In the embodiment, the searching module determines whether the location of the handheld device carried by the courier is in a preset area, and acquires the waybill numbers corresponding to the courier identification information according to the courier identification information and the relationship table when the location of the handheld device is in the preset area. The searching module further acquires all of the recipient addresses corresponding to the acquired waybill numbers according to the information table, and determines which recipient addresses are located in the preset area. The searching module determines the recipient contact information of each recipient whose address is within the preset area. In the embodiment, the preset area can be a few kilometers from a particular place. For example, the preset area can be an area two kilometers from a community. Furthermore, the searching module also divides a delivery area, which the courier is responsible for, into a number of preset areas.

At block 304, a contacting module informs the recipient whose recipient address is within the preset area to receive the corresponding parcel according to the recipient contact information determined by the contact searching module. In the embodiment, the contact method can be a phone number, the contacting module calls the recipient or sends a message to the recipient to inform the recipient to receive the parcel. Therein, the message sent by the contacting module includes delivery place and waiting time information.

In the embodiment, the parcel delivery management method 300 further includes steps: a location module acquires the location information of the handheld device determined by a GPS unit of the handheld device, and sends the acquired location information of the handheld device and the courier identification information to a cloud server. In the embodiment, the courier identification information can only include the number information of the handheld device, such as a cell phone number of the handheld device. In the embodiment, when the location module sends the acquired location information of the handheld device to the cloud server, the location module simultaneously sends the cell phone number of the handheld device to the cloud server.

In the embodiment, the parcel delivery management method 300 further includes steps: a recording module is used to acquire and add the waybill number, the recipient address, the recipient name, and the recipient contact information recorded in a waybill to the information table in response to an operation of inputting information by the courier when the courier receives a parcel with the waybill.

In the embodiment, the parcel delivery management method 300 further includes steps: an inquiring module provides a query interface and displays the query interface on a display unit of an electronic device carried by a user to inquire delivering information of a parcel for the user. In the embodiment, the delivering information includes default delivery time and location of a parcel. FIG. 5 illustrates the query interface includes an input box provided for the user to input a waybill number of the parcel. The inquiring module can acquire the waybill numbers of the parcel input by the user, and further determine the courier identification information corresponding to the waybill numbers according to the relationship table. The inquiring module can determine the default delivery time and location of the parcel according to the determined courier identification information, and display the default delivery time information and location of the parcel on the query interface. In the present embodiment, the inquiring module determines the location of the parcel according to the determined courier identification information corresponding to the location information of the handheld device acquired in the information module. In the present embodiment, the default delivery time of parcel can be set by default and the courier delivers the parcel according to the default delivery time. In other embodiments, the default delivery time is set by the courier.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A parcel delivery management system, to run in a hardware environment which comprises at least one handheld device, at least one electronic device, and at least one cloud server connected to each other, the cloud server storing an information table, the information table comprising waybill number information, recipient address information and recipient contact information, the parcel delivery management system comprising:
one or more processors, and
a plurality of modules having instructions for execution by the one or more processors, the modules comprising:
a binding module configured to provide an information input interface and display the information input interface on the handheld device to input and acquire the waybill number information of at least one parcel to be delivered and courier identification information of a courier to deliver the at least one parcel, associate the courier identification information with the waybill number information of at least one parcel to be delivered, and add the associated courier identification information and the waybill number information to a relationship table;
an information module configured to acquire location information of the handheld device carried by the courier and the courier identification information;
a searching module configured to determine the recipient contact information of the recipients whose recipient addresses are within a certain range from the location of the handheld device carried by the courier according to the acquired location information of the handheld device, the courier identification information, the information table, and the relationship table; and
a contacting module configured to inform the recipient whose recipient address is within the preset area to receive the corresponding parcels according to the recipient contact information determined by the searching module.

2. The parcel delivery management system according to claim 1, wherein the courier identification information comprises the number information of the handheld device.

3. The parcel delivery management system according to claim 1, wherein the searching module determines whether the location of the handheld device carried by the courier is in a preset area, and acquires the waybill numbers corresponding to the courier identification information according to the courier identification information and the relationship table when the location of the handheld device is in the preset area, the searching module further acquires all of the recipient addresses corresponding to the acquired waybill numbers according to the information table, and determines which recipient addresses are located in the preset area, the searching module determines the recipient contact information of each recipient whose address is within the preset area.

4. The parcel delivery management system according to claim 1, wherein the plurality of modules further comprise a location module configured to acquire the location information of the handheld device determined by a GPS unit of the handheld device, and send the acquired location information of the handheld device and the courier identification information to the cloud server.

5. The parcel delivery management system according to claim 1, wherein the recipient contact information can be a phone number, the contacting module calls the recipient or sends a message to the recipient to inform the recipient to receive the parcel.

6. The parcel delivery management system according to claim 1, wherein the plurality of modules further comprise a recording module configured to acquire and add the waybill number, the recipient address, and the recipient contact information recorded in a waybill to the information table in response to an operation of inputting information by the courier when the courier receives a parcel with the waybill.

7. The parcel delivery management system according to claim 1, wherein the plurality of modules further comprise an inquiring module configured to provide a query interface and display the query interface on a display unit of the electronic device carried by a user to inquire delivering information of the parcel for the user.

8. The parcel delivery management system according to claim 7, wherein the delivering information comprises default delivery time and location of a parcel.

9. A parcel delivery management method, comprising:
providing an information input interface and displaying the information input interface on a handheld device to input and acquire waybill number information of at least one parcel to be delivered and courier identification information of a courier to deliver the at least one parcel, associating the courier identification information with the waybill number information of at least one parcel to be delivered, and adding the associated courier identification information and the waybill number information to a relationship table;
acquiring location information of the handheld device carried by the courier and the courier identification information;
determining recipient contact information of the recipients whose recipient address are within a certain range from the location of the handheld device carried by the courier according to the acquired location information of the handheld device, the courier identification information, the relationship table, and an information table stored in a cloud server, the information table comprising the waybill number information, recipient address information and the recipient contact information for each recipient; and
informing the recipient whose recipient address is within the preset area to receive the corresponding parcel according to the recipient contact information.

10. The parcel delivery management method according to claim 9, wherein the courier identification information comprises the number information of the handheld device.

11. The parcel delivery management method according to claim 9, wherein the recipient contact information are acquired by:
determining whether the location of the handheld device carried by the courier is in a preset area, and acquiring the waybill numbers corresponding to the courier identification information according to the courier identification information and the relationship table when the location of the handheld device is in the preset area, and further acquiring all of the recipient addresses corresponding to the acquired waybill numbers according to the information table, and determining which acquired recipient addresses are located in the preset area, and determining the recipient contact information of each recipient whose address is within the preset area.

12. The parcel delivery management method according to claim 9, wherein the method further comprising:
acquiring the location information of the handheld device determined by a GPS unit of the handheld device, and sending the acquired location information of the handheld device and the courier identification information to the cloud server.

13. The parcel delivery management method according to claim 9, wherein the method further comprising:
acquiring and adding the waybill number, the recipient address, and the recipient contact information recorded in a waybill to the information table in response to an operation of inputting information by the courier when the courier receives a parcel with the waybill.

14. The parcel delivery management method according to claim 9, wherein the method further comprising:
providing a query interface and displaying the query interface on a display unit of the electronic device carried by a user to inquire delivering information of the parcel for the user.

15. The parcel delivery management method according to claim 14, wherein the delivering information comprises default delivery time and location of the parcel.
